(19) United States
(12) Patent Application Publication
(10) Pub. No.: US 2004/0162740 A1
(43) Pub. Date: Aug. 19, 2004

(54) Digitized prescription system

(76) Inventors: Arthur Dale Ericsson, Houston, TX (US); Tommy Eugene Hall JR., Houston, TX (US)

Correspondence Address: John R. Casperson, PO Box 2174, Friendswood, TX, 77549, US

(21) Appl. No.: 10/367,411

(22) Filed: Feb. 14, 2003

(51) Int. Cl. G06F 17/60

(52) U.S. Cl. 705/3

(57) ABSTRACT

An electronic database is provided which contains a plurality of transaction records for transactions in which a prescription medicinal substance is dispensed to a patient. Preferably the database is of nation-wide scope. Each transaction record contains a plurality of electronically associated data items including a medicinal substance data item and a patient data item. The database is operably associated with a computer means for searching the electronic database by at least one data item and identifying the transaction records containing such at least one data item, and performing at least one predetermined data processing function on the identified transaction records and generating a processed data packet. A communication means is operably associated with the computer means for communicating the processed data packet to a user. The database can be used to identify prescription fraud, medication overuse and abuse, and to provide an early warning for bioterror attacks.

### BACKGROUND OF THE INVENTION

This invention relates to data exchange between chain of commerce elements in the pharmaceutical industry.

The data exchange system currently in use in the United States is not well adapted to counter potential drug interactions or drug abuse. These problems are legendary. For example, abuse of legal prescriptions (legend pharmaceuticals), over-the-counter drugs and life style interactions occur, carrying with each the consequences of more than 100,000 deaths per year and a 10% rate of permanent disability. The known cost is between $20 and $75 billion per year but this includes only the reported data. The abuse problem grows in urgency in view of the dramatic rise in narcotic prescription (notably oxycontin) abuse in children and teens. While the pharmaceutical industry has attempted to address these problems by either providing print-out material with each filled prescription and/or provide the prescribing physician with a patient profile of drug use (if known), there is little attempt to coordinate these efforts.

Abuse of prescriptions often occurs by the patient placing written prescriptions in several independent pharmacies or chains and then asking for prescription filling before due dates. The patient therefore may be taking excessive amounts of drugs. This infraction is most common with sedatives, narcotics and tranquilizers. Moreover, if different prescriptions are filled at different pharmacies then each is unaware of the multiple and potential interactive dugs that each patient is taking. A data exchange system to overcome this inadequacy is needed.

Many prescription (and non-prescription) drugs have lethal interactive consequences, called adverse drug reactions. These occur most frequently with combinations of sedatives-narcotics-tranquilizers. These are rarely reported to the FDA using adverse drug reaction forms, as required by law. Further, all drugs (prescription as well as over-the-counter drugs) have the potential for drug interactions which can be serious for the patient. Additionally, idiosyncratic (individual) reactions may occur to any form of medication. These are individual responses and are often either not reported or not coded for future potential drug interactions. A data exchange system to insure such interactions are reported is badly needed.

Further, almost 40% of all drugs bypass traditional pharmacies and are dispensed directly by the physician or clinic. Increasingly, there is unauthorized sale of prescription medications via catalog or Internet usually without a health professional. A system to track such drug dispensing is necessary to reduce interactions and potential abuse.

As an additional shortcoming, there is often a time delay in prescription refills as the prescribing health professional must be contacted by telephone or facsimile prior to a refill date for each prescription written. Therefore, it would be useful to provide a method for increasing the ease of prescription refills in an appropriate and timely manner.

Many of the problems noted above arise from poor lines of communication and lack of data exchange. A patient usually has multiple prescribing health professionals who do not always communicate with each other. The patient may or may not be aware of potential interactions and life style problems that may exist. Prescriptions are filled from a variety of sources who do not always know of prescriptions being filled from other sources. The FDA is the responsible resource for all adverse drug reactions but only has reported information to rely upon. The pharmaceutical manufacturers must report any all reactions and should monitor post marketing drug effects but often also rely upon incomplete information.

### OBJECTS OF THE INVENTION

It is an object of this invention to provide a prescription dispensing system that could virtually eliminate fraud and abuse.

It is a further object of this invention to provide a prescription dispensing system that would reduce the number of adverse reactions drug interactions to prescription medications and could facilitate FDA adverse reaction notification via the secure Internet.

It is another object of this invention to provide a prescription dispensing system that could virtually eliminate all of the nonprofessional abuse of national or Internet pharmacy services.

It is another object of this invention to help to control the over use of medications by patients by forcing the prescribing health professional to set limits on drugs used.

It is another object of this invention to provide the health professional with valuable data on his patients' use or abuse of prescription medication—by a method of feedback (oral, fax or Internet).

It is another object of this invention to facilitate the dispensing pharmacist in making refills with ease easier via the Internet and to allow the pharmacist to view potential prescription abuse.

It is another object of this invention to not alter the existing reporting system to drug manufacturers but rather, by the interactive nature of the secure Internet, make available data more readily and completely available.

### SUMMARY OF THE INVENTION

Broadly, the present invention comprises an electronic database containing a plurality of transaction records for transactions in which a prescription medicinal substance is dispensed to a patient and methods and structure for its implementation and use. Each transaction record contains a plurality of electronically associated data items including a medicinal substance data item and a patient data item. The database is operably associated with a computer means for searching the electronic database by at least one data item and identifying the transaction records containing such at least one data item, and performing at least one predetermined data processing function on the identified transaction records and generating a processed data packet. A communication means is operably associated with the computer means for communicating the processed data packet to a user.

### BRIEF DESCRIPTION OF THE DRAWINGS

FIG. 1 is a schematic illustrating a data flow path to form a database according to one embodiment of the invention.

FIG. 2 is a schematic illustrating data association flow paths to provide various utilities according to other embodiments of the invention.

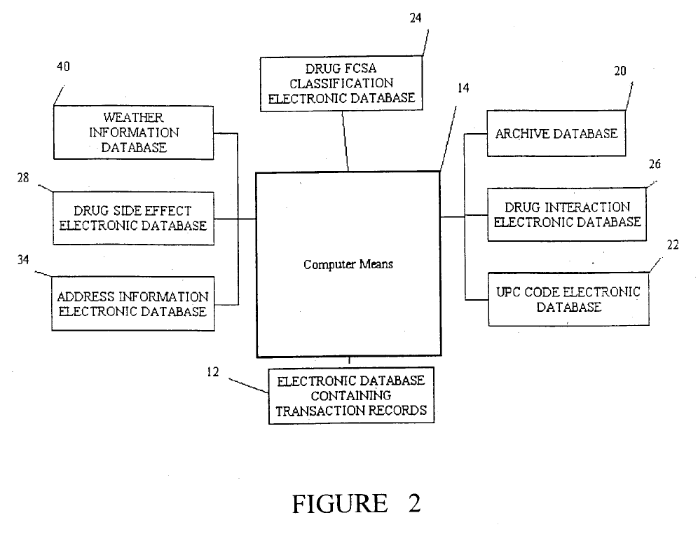

FIG. 3 is a schematic illustrating communication flow paths to provide additional utilities according to additional embodiments of the invention.

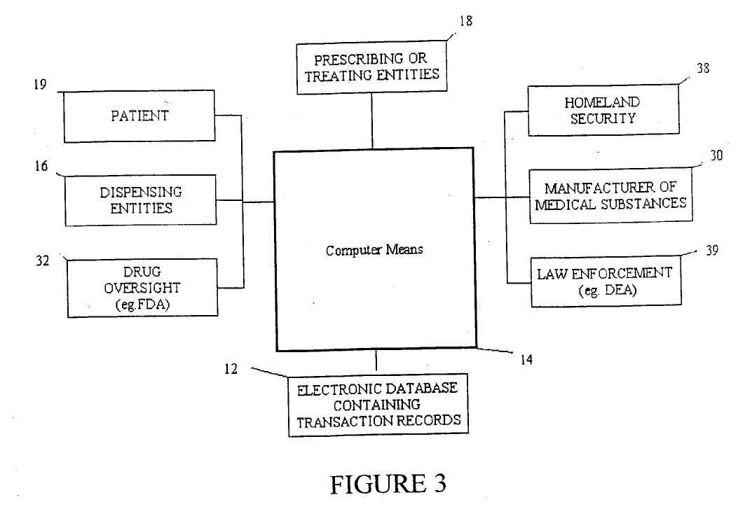

### DETAILED DESCRIPTION OF THE INVENTION

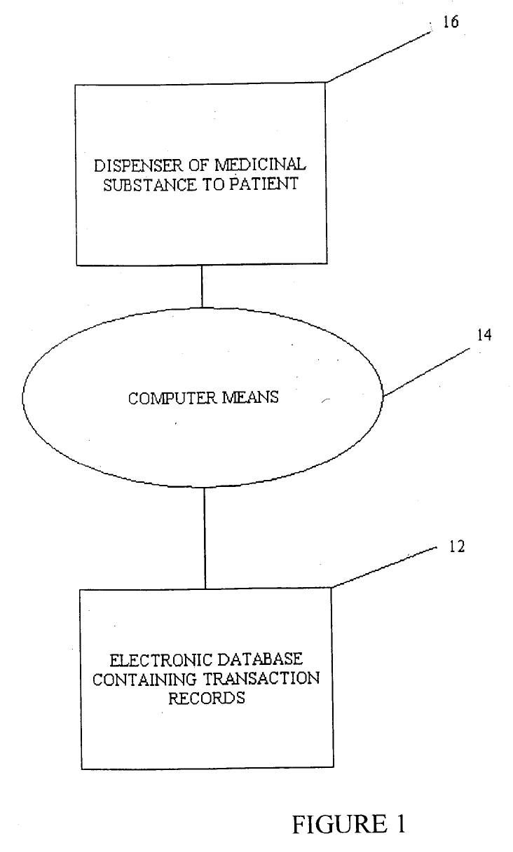

The most important feature of the present invention is an electronic database 12 containing a plurality of transaction records for transactions in which a prescription medicinal substance is dispensed to a patient. Each transaction record contains a plurality of electronically associated data items including a medicinal substance data item and a patient data item. The database is operably associated with a computer means 14 for searching the electronic database by at least one data item and identifying the transaction records containing such at least one data item, and performing at least one predetermined data processing function on the identified transaction records and generating a processed data packet. A communication means is operably associated with the computer means for communicating the processed data packet to a user. FIG. 1 schematically illustrates a preferred data flow for forming the database.

In order to provide best results, it is preferred that the electronic database contains transaction records for substantially all transactions in which at least one predetermined type of prescription medicinal substance was dispensed to a patient within a predetermined geographic region over a period of time. The predetermined geographic region is preferably nationwide, such as, for example, the United States. It is also preferable that the inputs to the database be standardized. For example, it is preferred that the medicinal substance data item be a unique identifier for the medicinal substance, for example, the UPC number, and that the patient data item be a unique identifier for the patient, for example, patient's social security number. However, inputs could be properly electronically associated with proper UPC number by data exchange with a UPC database 22. Also, it would be desirable that the database be compiled and maintained with minimal effort on the part of those charged with its compilation. For this reason, it is preferred that the transaction records be input by the dispensers 16 of the medicinal substances which are the subject of the transaction record. Normally, the dispenser will be a pharmacist, although in some instances the dispenser may be a health clinic or physician. See FIG. 1.

It is preferred that the database contain transaction records for all transactions in which dispensement of a prescription medicinal substance occurred. The computer means therefore preferably further includes means for receiving transaction records from remote sources and adding the received transaction records to the electronic database. However, the database will not necessarily contain transaction records for all dispensed prescription medicinal substances, as the database can be useful even if not exhaustive by targeting transactions involving only certain types of medicinal substances. For example, where the at least one predetermined type of prescription medicinal substance is controlled substances listed in Schedules II, III, IV or V of the Federal Controlled Substances Act or implementing regulations, data can be retrieved from the database indicating use, abuse or overuse of these substances. If necessary, the appropriate FCSA classification for a particular medical substance can be electronically associated with the relevant transaction records by data exchange with an electronic FCSA classification database 24. Where the at least one predetermined of prescription medicinal substance is systemic biocides classified as systemic antibiotics or systemic antivirals, data can be retrieved from the database indicating a possible bioterror attack, disease outbreak, or possibly the emergence of antibiotic-resistant strains of bacteria.

Generally speaking, therefore, it is preferred that a transaction record is transmitted to the apparatus of the invention for substantially all transactions occurring in the United States in which a prescription medicinal substance of at least one predetermined type is dispensed to a patient. To keep the database current, transaction records are transmitted to the apparatus from remote sources for addition to the electronic database, preferably substantially contemporaneously with the transaction. To keep the overhead associated with the system at a low level, the remote sources are dispensers of prescription medicinal substances, normally the pharmacist, who already enter much of the needed information into locally maintained computer databases.

For numerous reasons, it would sometimes be desirable to obtain a patient's medication history. In order to obtain such history, the transactions must be associated with a data item indicative of the date of the transaction. The date information can be entered as part of the transaction record, or associated with the transaction record upon receipt by the database. For this utility, the at least one predetermined data processing function further should have the capability of identifying the transaction records in date order for at least one medicinal substance dispensed to a patient. In order to obtain the medication history, the electronic database containing the above noted information is searched by the patient's social security number and a set of transaction records containing such number identified. These transaction records are sorted into subsets by UPC number of the medicinal substance and arranged in the subsets by date order. A data packet containing the arranged information is then communicated to a user, usually a requester such as a physician, although it could be the patient, via the communication means. If desired, an archive database 20 can be further searched for transactions no longer maintained in the system.

The just described database with associated data processing function can also be used to obtain a patient's prescription fill history for a particular medicinal substance. For this purpose, the electronic database is searched by both patient social security number and the UPC number of the medicinal substance and a set of transaction records containing such numbers is identified and arranged in date order to form a data packet which is transmitted to the user.

By further providing the database with a data item associated with each transaction record indicative of the quantity of the medicinal substance dispensed in the transaction, the necessary data for determining whether a particular medicinal substance is possibly being overused is available. For this functionality, the at least one predetermined data processing function includes making a determination of the aggregate quantity of a medicinal substance dispensed over a predetermined date range and indicating the results of the determination in the data packet. Preferably, the electronic database further contains at least one data item associated with each transaction record indicative of the size of the medicinal substance dispensed in the transaction and at least one data item associated with each transaction record indicative of the dose rate for the medicinal substance and the computer means for performing the at least one predetermined data processing function further includes means for receiving and making a determination on a query regarding whether a proposed transaction is indicative of overuse of a medicinal substance and indicating the determination in the data packet. The apparatus can be used to determine whether a proposed refill or remaining fill transaction is indicative of potential overuse of a medicinal substance under an authorizing prescription. The electronic database is searched by patient social security number and the UPC number of the medicinal substance and a set of transaction records containing such numbers is identified. The set of transaction records is searched for data items indicative of transaction records pertaining the authorizing prescription and a subset of such records is formed. The most recent of such transaction records, is identified and, from the data item indicating the quantity of medicinal substance prescribed and the data item indicating the dosage rate contained in such most recent transaction record, a theoretical refill date is calculated. Whether the proposed transaction is to occur more than a predetermined period of time prior to said theoretical refill date is determined and a data packet containing the results of such determination is formed and communicated the data packet to a user via the communication means.

The data can also be sorted and reports generated to enable the identification of potential counterfeiting or illicit importation of prescription medicinal substances. For this application, the electronic database would be searched by the UPC number of the medicinal substance and transaction date to identify transactions for a predetermined medicinal substance occurring over a predetermined period of time. The quantities of the medicinal substance dispensed over such period of time would be determined. The determined quantities would be compared with quantities indicated in an electronic database containing sales data from the manufacturer for the medicinal substance during such period of time. A determination would be made of whether any differences between the quantities determined from the transaction records and the quantities indicated by the sales records exceed a predetermined value. A data packet would be formed containing the results of such determination, and communicated to a user via the communication means.

The database containing the date information further provides a basis for determining a patient's current medication regimen, and ascertaining the possibility of interactions with current medications or proposed changes to the current regimen or side effects. In order to provide this functionality, the computer means for performing the at least one predetermined data processing function should further include means for making a determination of possible interactions between a patient's recently dispensed medicinal substances or side effects and indicating the determination in the data packet. The means will generally include accessing a separate drug interaction database 26 and or a side effect database 28, although the required information may be stored in the same equipment as the transaction database. The interaction database can further contain possible interaction information for the medicinal substance with non-medicinal items, such as alcohol or food. To provide the capability of determining whether a proposed transaction may interact with previously dispensed medicinal substances or have side effect, the electronic database further contains a data item associated with each transaction record indicative of the date of the transaction. The computer means for performing the at least one predetermined data processing function further includes means for receiving and making a determination on a query regarding whether a proposed transaction will result in possible interactions with a patient's recently dispensed medicinal substances or side effects and indicating the determination in the data packet. To use, the electronic database is searched by patient social security number and transaction date to identify the patient's recently dispensed medicinal substances. A determination is made of whether the medicinal substance of the proposed transaction has any known side effects or interactions with the identified recently dispensed medicinal substances. A data packet is formed containing the results of such determination and communicated to a user via the communication means.

To facilitate communication with the prescribing and dispensing entities, the electronic database further preferably contains at least one data item associated with each transaction indicative of the identity of the dispensing entity and at least one data item indicative of the identity of the prescribing entity. A digital signature from the prescribing entity evidencing authorization for the dispensement can be included in the data for the prescribing entity. Preferably, the database contains unique identifiers for both the prescribing entity and the dispensing entity. For example, the unique identifiers can be the license numbers for each of the prescribing entity and the dispensing entities.

In order to better identify unauthorized transactions, the database needs to contain information relating to at least the identity of the authorizing prescriptions and at least any obvious fill limitations, such as an expiration date and whether generic substitution is authorized. The electronic database therefore preferably further contains a data item associated with each transaction record indicative of an identity of an authorizing prescription and at least one data item associated with each transaction record indicative of prescription fill limitations. The predetermined data processing function includes a means for determining whether a transaction resulted in a violation of such prescription fill limitations and identifying any such transactions in the processed data packet, which in this case may be sent to law enforcement authorities 39.

As an additional utility, the apparatus is easily provided with a mechanism to determine whether a proposed transaction will result in a violation prescription fill limitations. For this purpose, the computer means for performing the at least one predetermined data processing function further includes means for receiving and making a determination on a query regarding whether a proposed transaction will violate prescription fill limitations and indicating the determination in the data packet. The apparatus is used by submitting a query to cause the apparatus to search the electronic database by patient social security number and UPC number of the medicinal substance and identify a set of transaction records containing such numbers. It then searches the set of transaction records for data items indicative of prescription fill limitations, forms a subset of such transaction records, and identifies the most recent transaction record of the subset. The apparatus then makes a determination of whether the proposed transaction will violate the prescription fill limitation associated with the most recent transaction record, forms a data packet indicating the results of such determination, and communicates the data packet to a user via the communication means.

The just described apparatus and method are most useful where the determination of whether or not a remaining fill/refill transaction is authorized is a simple one. Determination of whether there is still, or was, “room” for a remaining fill/refill transaction is somewhat more complicated, but well within the capabilities of the invention. In order to provide this functionality, the electronic database further contains at least one data item associated with each transaction record indicative of the quantity of medicinal substance dispensed in the transaction. The at least one data item indicative of prescription fill limitations includes a data item indicating the quantity of medicinal substance prescribed and a data item indicating the number of authorized refills. The at least one predetermined data processing function includes aggregating the quantities of a medicinal substance previously dispensed pursuant to an authorizing prescription. The apparatus is preferably used to respond to a query regarding whether a proposed refill or remaining fill transaction will violate aggregated quantity limits for a medicinal substance under an authorizing prescription. In response to the query, the electronic database is searched by patient social security number and the UPC number of the medicinal substance and a set of transaction records containing such numbers is identified. The set of transaction records is searched for data items indicative of transaction records pertaining to the authorizing prescription and a subset of such records is formed. The quantities of the medicinal substance previously dispensed pursuant to the authorizing prescription are aggregated, and from the data item indicating the quantity of medicinal substance prescribed and the data item indicating the number of authorized refills, a maximum authorized quantity under the authorizing prescription is calculated. Whether the proposed transaction will exceed the maximum authorized quantity is determined and a data packet indicating the results of such determination is formed and communicated to the user via the communication means.

At present, there does not exist a highly organized system to promptly determine the outbreak of disease. The invention can easily provide data showing elevated prescription activity for antibiotic and antiviral substances. Since many acts of bioterroism will produce initial signs and symptoms which would appear to be treatable by such substances, elevated prescription activity could serve as an early warning that an attack is underway. For this function, the electronic database further contains a data item associated with each transaction record indicative of the date of the transaction and a data item associated with each transaction record indicative of the location of the transaction. The data item for location could be zip code, for example, would be electronically associated with the dispensers associated with the transaction records by exchanging data with an address information database 34. The computer means for performing the at least one predetermined data processing function further includes means for making a determination of whether recent transactions for systemic biocides depart from historic data for a given region and indicating the determination in the data packet. The information could be transmitted to the appropriate authorities, such as the CDC or Homeland Security 38, either in response to a query, or in a regularly scheduled report, or as an automatically generated report should the prescription activity level exceed certain predetermined limits or show more than a predetermined increase. If desired weather conditions can be factored into the establishment of the predetermined limits by data exchange with a weather information database 40. To use the apparatus, the electronic database is searched to identify transaction records for at least one medicinal substance classified as a systemic biocide. The identified transaction records are sorted into at least one subset based on at least one geographic locality, one subset per locality. The subsets are arranged in date order. A value representative of prescription activity for the at least one systemic biocide dispensed in each geographic locality over a predetermined period of time is then assigned. The determination is then made of whether any such assigned values depart from historic values for the same geographic localities and a data packet if formed containing the results of such determination. The data packet is communicated to the user via the communication means.

It is preferred to provide the apparatus with capabilities to associate additional information with the transaction records. Generally, the information will be in the form of data from remote sources, and in such case the computer means further includes means for receiving data from remote sources and associating said data with the transaction records and the apparatus would be used by transmitting data related to a transaction record to the means for receiving data from remote sources for association with a transaction record.

For example, the means for receiving data from remote sources can include means for receiving a digital signature from remote sources to authorize transactions in which a prescription medicinal substance is dispensed to a patient and the communication means is further operable to communicate such digital signatures to dispensers 16, 16′, which can be the same or different from the dispenser which input the transaction information into the database. One way in which this aspect of the invention can be usefully implemented by providing the means for receiving data from remote sources with means for receiving requests for fill authorizations from dispensers and means for receiving authorizations-to-fill from prescribers 18 and in such case the communication means is further operable to communicate requests from the dispenser to the prescriber and authorizations from the prescriber to the dispenser. The apparatus would be used by transmitting requests for fill authorizations from the dispenser to the means for receiving data from remote source and receiving authorizations to complete the fill transaction from the communication means. Another example is associating follow-up data from the prescribing entity with the transaction record. For example, the data transmitted by the prescribing entity could indicate observations selected from the group consisting of side effect information, interaction information and efficacy information related to the prescribed medicinal substance. The side effect information could be used to update the database 28 and the interaction information could be used to update the database 26. The utility of facilitating the distribution of recall notices from the manufacturer 30 or from a government entity such as the FDA 32 is provided where the means for receiving data from remote sources includes means for receiving notices concerning medicinal substances and the communications means is further operable to communicate such notices to dispensers and prescribers of such medicinal substances. The apparatus could be used by receiving a recall notice concerning a medicinal substance at the means for receiving data from remote sources and transmitting such notice to the prescribers and dispensers associated with such medicinal substance in at least a portion of the transaction records. Other useful information, for example, possible drug interactions with a medicinal substance, side effects for a medicinal substance, and sales data for a medicinal substance could be transmitted by the manufacturer of the medicinal substance and associated with transactions in the database.

Additional Implementation Information

1. Develop prescription software program that will incorporate:

A. The category (FDA schedule-II-V) should be allocated for each prescription. Each actual drug will be given an identifying number-this may be the UPC number as this number identifies the product, expiration date as well as the manufacturer.

B. An individual patient identifying number must be entered. A social security number or other patient identifying number may be used.

C. A unique health professional identifying number (use the Federal DEA number or state license number). Require the prescribing health professional to state minimum or maximum number and time for refill on all prescriptions. Furthermore, require that all physicians or clinics that dispense drugs register the patient, physician and/or dispensing clinic identifying number in the manner described above for each product dispensed.

D. A dispensing pharmacist identifying number (Federal or state license number). Require that all chain pharmacies be identified by their identifying number as well as the individual store and pharmacist working within these chains. Further, require that all pharmacists filling prescriptions register each drug dispensed and entered into the secure national database along with patient identifying and physician identifying number.

2. Procedure or Operations

A. Thus when a prescription is written and delivered to a pharmacy for dispensing each of the above numbers are entered into the national federal secure intranet database.

B. The identifying patient numbers will discern when each patient is taking a variety of different drugs from a number of health professionals and pharmacies.

C. Notification of the health professionals involved (pharmacists-physicians, etc.) may be made via mail, fax or the internet email of potential dangers or fraud.

D. Refill authorization may be axiomatic if the patient is held within time limits and amounts as set by the health professional prescribing each pharmaceutical. This may be performed by telephone, fax or email.

3. Physician Feedback

Physician feedback on efficacy of treatment could be in accord with U.S. Pat. No. 5,993,386 (Computer assisted method for the diagnosis and treatment of illness), the disclosure of which is incorporated by reference.

While certain preferred embodiments of the invention have been described hereinabove, the invention is not to be construed as being so limited, except to the extent that such limitations are found in the claims.

What is claimed is:

1. Apparatus comprising
an electronic database containing a plurality of transaction records for transactions in which a prescription medicinal substance is dispensed to a patient, each transaction record containing a plurality of electronically associated data items including a medicinal substance data item and a patient data item,
computer means for
searching said electronic database by at least one data item and identifying the transaction records containing such at least one data item, and
performing at least one predetermined data processing function on the identified transaction records and generating a processed data packet, and
communication means operably associated with the computer means for communicating the processed data packet to a user.

2. Apparatus as in claim 1 wherein
the electronic database contains transaction records for substantially all transactions in which at least one predetermined type of prescription medicinal substance was dispensed to a patient within a predetermined geographic region over a period of time.

3. Apparatus as in claim 2 wherein the predetermined geographic region is the United States.

4. Apparatus as in claim 3 wherein the medicinal substance data item is a unique identifier for the medicinal substance and the patient data item is a unique identifier for the patient.

5. Apparatus as in claim 4 wherein the medicinal substance data item is the UPC number for the medicinal substance and the unique identifier for the patient is the patient's social security number.

6. Apparatus as in claim 5 wherein the at least one predetermined type of prescription medicinal substance is controlled substances listed in Schedules II, III, IV or V of the Federal Controlled Substances Act or implementing regulations.

7. Apparatus as in claim 5 wherein the at least one predetermined type of prescription medicinal substance is systemic biocides classified as systemic antibiotics or systemic antivirals.

8. Apparatus as in claim 5
wherein the electronic database further contains a data item associated with each transaction record indicative of the date of the transaction and a data item associated with each transaction record indicative of an identity of an authorizing prescription, and
the at least one predetermined data processing function further includes identifying the transaction records in date order for at least one medicinal substance dispensed to a patient.

9. Apparatus as in claim 8 wherein the electronic database further contains at least one data item associated with each transaction record indicative of prescription fill limitations and the at least one predetermined data processing function includes determining whether a transaction resulted in a violation of such prescription fill limitations and identifying any such transactions in the processed data packet.

10. Apparatus as in claim 8 wherein the electronic database further contains at least one data item associated with each transaction record indicative of prescription fill limitations,
and said computer means for performing the at least one predetermined data processing function further includes means for receiving and making a determination on a query regarding whether a proposed transaction will violate prescription fill limitations and indicating the determination in the data packet.

11. Apparatus as in claim 10 wherein the electronic database further contains at least one data item associated with each transaction record indicative of the quantity of medicinal substance dispensed in the transaction and the at least one data item indicative of prescription fill limitations includes a data item indicating the quantity of medicinal substance prescribed and a data item indicating the number of authorized refills, wherein the at least one predetermined data processing function includes aggregating the quantities of a medicinal substance previously dispensed pursuant to an authorizing prescription.

12. Apparatus as in claim 8 wherein the electronic database further contains at least one data item associated with each transaction record indicative of the size of the medicinal substance dispensed in the transaction and at least one data item associated with each transaction record indicative of the dose rate for the medicinal substance,
and said computer means for performing the at least one predetermined data processing function further includes means for receiving and making a determination on a query regarding whether a proposed transaction is indicative of overuse of a medicinal substance and indicating the determination in the data packet.

13. Apparatus as in claim 7 wherein the electronic database further contains a data item associated with each transaction record indicative of the date of the transaction and a data item associated with each transaction record indicative of the location of the transaction and said computer means for performing the at least one predetermined data processing function further includes means for making a determination of whether recent transactions for systemic biocides depart from historic data for a given region and indicating the determination in the data packet.

14. Apparatus as in claim 13 wherein the data item indicative of the location of the transaction is the postal code of the dispenser.

15. Apparatus as in claim 5 wherein the electronic database further contains a data item associated with each transaction record indicative of the date of the transaction and said computer means for performing the at least one predetermined data processing function further includes means for making a determination of possible interactions between a patient's recently dispensed medicinal substances or side effects and indicating the determination in the data packet.

16. Apparatus as in claim 5 wherein the electronic database further contains a data item associated with each transaction record indicative of the date of the transaction,
and said computer means for performing the at least one predetermined data processing function further includes means for receiving and making a determination on a query regarding whether a proposed transaction will result in possible interactions with a patient's recently dispensed medicinal substances or cause side effects and indicating the determination in the data packet.

17. Apparatus as in claim 5 wherein the electronic database further contains at least one data item associated with each transaction indicative of the identity of the dispensing entity and at least one data item indicative of the identity of the prescribing entity.

18. Apparatus as in claim 17 wherein the at least one data item indicative of the identity of the prescribing entity includes a digital signature for the prescribing entity.

19. Apparatus as in claim 17 wherein dispensing entity data item is a unique identifier for the dispensing entity and the prescribing entity data item is a unique identifier for the prescribing entity.

20. Apparatus as in claim 19 wherein the unique identifier for the dispensing entity is a license number and the unique identifier for the prescribing entity is a license number.

21. Apparatus as in claim 5 wherein the electronic database further contains a data item associated with each transaction record indicative of the date of the transaction and a data item associated with each transaction record indicative of the quantity of the medicinal substance dispensed in the transaction, and wherein the at least one predetermined data processing function includes making a determination of the aggregate quantity of a medicinal substance dispensed over a predetermined date range and indicating the results of the determination in the data packet.

22. Apparatus as in claim 1 wherein said computer means further includes means for receiving transaction records from remote sources and adding the received transaction records to the electronic database.

23. Apparatus as in claim 22 wherein said computer means further includes means for receiving data from remote sources and associating said data with the transaction records.

24. Apparatus as in claim 23 wherein the means for receiving data from remote sources includes means for receiving a digital signature from remote sources to authorize transactions in which a prescription medicinal substance is dispensed to a patient and the communication means is further operable to communicate such digital signatures to dispensers.

25. Apparatus as in claim 22 wherein the means for receiving data from remote sources includes means for receiving requests for fill authorizations from dispensers and means for receiving authorizations to fill from prescribers and the communication means is further operable to communicate requests from the dispenser to the prescriber and authorizations from the prescriber to the dispenser.

26. Apparatus as in claim 22 wherein the means for receiving data from remote sources includes
means for receiving notices concerning medicinal substances and the communications means is further operable to communicate such notices to dispensers and prescribers of such medicinal substances.

27. A method of using an apparatus as in claim 22 comprising
transmitting transaction records to said apparatus from remote sources for addition to the electronic database.

28. A method as in claim 27 wherein the remote sources are dispensers of prescription medicinal substances.

29. A method as in claim 28 wherein a transaction record is transmitted to said apparatus for substantially all transactions occurring in the United States in which a prescription medicinal substance of at least one predetermined type is dispensed to a patient.

30. A method as in claim 29 wherein the transaction record for a transaction is transmitted by the dispenser of the prescription medication for the transaction for essentially all transactions in which a prescription medicinal substance is dispensed to a patient.

31. A method of using an apparatus as in claim 8 to obtain a patient's medication history comprising
searching the electronic database by the patient's social security number and identifying a set of transaction records containing such number;
sorting the set of transaction records into subsets by UPC number of the medicinal substance,
arranging the transaction records in the subsets by date order to form a data packet, and
communicating the data packet to a user via the communication means.

32. A method of using an apparatus as in claim 8 to obtain a patient's prescription fill history for a medicinal substance comprising
searching the electronic database by patient social security number and the UPC number of the medicinal substance, and identifying a set of transaction records containing such numbers,
arranging the transaction records in date order to form a data packet, and communicating the data packet to a user via the communication means.

33. A method of using an apparatus as in claim 10 to determine whether a proposed transaction will violate prescription fill limitations for a medicinal substance comprising
searching the electronic database by patient social security number and the UPC number of the medicinal substance and identifying a set of transaction records containing such numbers,
searching the set of transaction records for data items indicative of prescription fill limitations and forming a subset of transaction records,
identifying the most recent transaction record of the subset,
determining whether the proposed transaction will violate the prescription fill limitation associated with the most recent transaction record and forming a data packet indicating the results of such determination, and
communicating the data packet to a user via the communication means.

34. A method of using an apparatus as in claim 11 to determine whether a proposed refill or remaining fill transaction will violate aggregated quantity limits for a medicinal substance under an authorizing prescription comprising
searching the electronic database by patient social security number and the UPC number of the medicinal substance and identifying a set of transaction records containing such numbers,
searching the set of transaction records for data items indicative of transaction records pertaining to the authorizing prescription and forming a subset of such records,
aggregating the quantities of the medicinal substance previously dispensed pursuant to the authorizing prescription,
calculating, from the data item indicating the quantity of medicinal substance prescribed and the data item indicating the number of authorized refills, a maximum authorized quantity under the authorizing prescription,
determining whether the proposed transaction will exceed the maximum authorized quantity and forming a data packet indicating the results of such determination, and
communicating the data packet to a user via the communication means.

35. A method of using an apparatus as in claim 12 to determine whether a proposed refill or remaining fill transaction is indicative of potential overuse of a medicinal substance under an authorizing prescription, said method comprising
searching the electronic database by patient social security number and the UPC number of the medicinal substance and identifying a set of transaction records containing such numbers,
searching the set of transaction records for data items indicative of transaction records pertaining the authorizing prescription and forming a subset of such records,
identifying the most recent of such transaction records,
calculating, from the data item indicating the quantity of medicinal substance prescribed and the data item indicating the dosage rate contained in such most recent transaction record, a theoretical refill date,
determining whether the proposed transaction is to occur more than a predetermined period of time prior to said theoretical refill date and forming a data packet containing the results of such determination, and
communicating the data packet to a user via the communication means.

36. A method of using an apparatus as in claim 13 to determine whether prescription activity in a given geographic area is indicative of potential disease outbreak or act of bioterrorism, said method comprising
searching the electronic database to identify transaction records for at least one medicinal substance classified as a systemic biocide,
arranging said transaction records into at least one subset based on at least one geographic locality, one subset per locality,
arranging the subsets in date order,
assigning a value representative of prescription activity for the at least one systemic biocide dispensed in each geographic locality over a predetermined period of time,
determining whether any such assigned values depart from historic values for the same geographic localities and forming a data packet containing the results of such determination, and
communicating the data packet to a user via the communication means.

37. A method of using an apparatus as in claim 16 to determine whether a medicinal substance in a proposed transaction will result in possible interactions with a patient's recently dispensed medicinal substances, said process comprising
searching the electronic database by patient social security number and transaction date to identify the patient's recently dispensed medicinal substances,
determining whether the medicinal substance of the proposed transaction has any known interactions with the identified recently dispensed medicinal substances and forming a data packet containing the results of such determination, and
communicating the data packet to a user via the communication means.

38. A method of using an apparatus as in claim 21 to identify potential counterfeiting or illicit importation of prescription medicinal substances, said method comprising
searching the electronic database by the UPC number of the medicinal substance and transaction date to identify transactions for a predetermined medicinal substance occurring over a predetermined period of time,
determining the quantities of the medicinal substance dispensed over such period of time,
comparing the determined quantities with quantities indicated in an electronic database containing sales data from the manufacturer for the medicinal substance during such period of time,
determining whether any differences between the quantities determined from the transaction records and the quantities indicated by the sales records exceed a predetermined value and forming a data packet containing the results of such determination, and
communicating the data packet to a user via the communication means.

39. A method of using an apparatus as in claim 22 comprising
transmitting data related to a transaction record to the means for receiving data from remote sources for association with a transaction record.

40. A method as in claim 39 wherein the data is transmitted by the prescribing entity and indicates observations selected from the group consisting of side effect information, interaction information and efficacy information related to the prescribed medicinal substance.

41. A method as in claim 39 wherein the data is transmitted by a manufacturer of the medicinal substance and is selected from the group consisting of possible drug interactions with a medicinal substance, side effects for a medicinal substance, and sales data for a medicinal substance.

42. A method of using an apparatus as in claim 25 comprising transmitting a request for a fill authorization from a dispenser to the means for receiving data from a remote source and receiving an authorization to complete the fill transaction from the communication means.

43. A method of using an apparatus as in claim 26 comprising receiving a recall notice concerning a medicinal substance at the means for receiving data from remote sources and transmitting such notice to the prescribers and dispensers associated with such medicinal substance in at least a portion of the transaction records.
